(19) United States
(12) Patent Application Publication
(10) Pub. No.: US 2015/0371452 A1
(43) Pub. Date: Dec. 24, 2015

(54) DYNAMIC ROAD PRICING METHOD, SYSTEM, AND NON-TRANSITORY COMPUTER READABLE STORAGE MEDIUM

(71) Applicant: INSTITUTE FOR INFORMATION INDUSTRY, Taipei (TW)

(72) Inventor: Rung-Ren LIN, Taipei City (TW)

(21) Appl. No.: 14/316,756

(22) Filed: Jun. 26, 2014

(30) Foreign Application Priority Data
Jun. 19, 2014 (TW) 103121188

(51) Int. Cl. G07B 15/06

(52) U.S. Cl. CPC G07B 15/06

(57) ABSTRACT

A dynamic road pricing method includes the following operations. A data table of traffic flow and toll rate associated with multiple time segments is stored in a database on a storage device. A mathematical model of the traffic flow and the toll rate is built and the mathematical model of the traffic flow and the toll rate includes a value of at least one parameter related to a road segment and a time segment. A raw toll rate is calculated according to the values of the parameters and a rated traffic flow. A difference of the raw toll rate and a first announced toll rate of a previous time segment is calculated, and a second announced toll rate of the time segment is determined according to the raw toll rate and the difference.

### RELATED APPLICATIONS

This application claims priority to Taiwan Application Serial Number 103121188, filed Jun. 19, 2014, which is herein incorporated by reference.

### BACKGROUND

1. Field of Invention

The present disclosure relates to a system, method and non-transitory computer readable storage medium of road pricing. More particularly, the present disclosure relates to a system, method and non-transitory computer readable storage medium of dynamic road pricing.

2. Description of Related Art

The invention of vehicles and establishments of road networks make transportation convenient and efficient more than ever. However, with the growing number of vehicles, traffic congestion has become a major issue in many areas. It not only causes a waste of time, pollution from exhaust emission, and even “road rage” which seriously influences the mental health of drivers and road traffic safety.

Traffic congestion basically occurs when demand for roads is higher than road capacity and is a supply/demand problem. To deal with the problem from the supply side means widening existed roads or building new roads, but the resulted cost is high. Moreover, the demand far roads is characterized with variation according to time such as peak and off-peak hour. If new roads are constructed to accommodate the demand of peak hour, an over-supply occurs during off-peak hours, which is not economical. As a result, various approaches are proposed and implemented to solve the problem from the demand side, such as limiting the incoming traffic flow at road entrances, enforcing a high occupancy rule, or prohibiting cars with certain car plates to use the road on certain weekdays. However, these methods all suppress the demand by putting a restriction on all drivers and thus causing great inconvenience.

Controlling the demand with pricing (i.e. applying the law of demand and supply) is also proposed, and one of the advantages is that drivers are allowed to choose whether to accept the price for a trip or not, while incoming traffic flow is still regulated by road pricing to avoid traffic congestion. Drivers also become more aware of the impact they exert on others and the environment through paying for using the road. Road pricing has been in practice for many years. Nonetheless, fixed rate pricing is still used in many areas whether fees are collected at fixed points or by mileage. The pricing power remains under-utilized for solving the excess demand over supply of roads at peak hour.

### SUMMARY

In one aspect, the present disclosure is directed to a dynamic road pricing method including operations as follows. A data table of traffic flow and toll rate associated with multiple time segments is built. A mathematical model of the traffic flow and the toll rate is bunt and includes a value of at least one parameters related to a road segment and a time segment. A raw toll rate of the road segment and the time segment is calculated according to the values of the parameters and a rated traffic flow. A first announced toll rate of a previous time segment is retrieved and a difference between the raw toll rate and the first announced toll rate is calculated. A second announced toll rate of the time segment is determined according to the raw toll rate and the difference.

In another aspect, the present disclosure is directed to a dynamic road pricing system including a storage device and a processor. A database is stored in the storage device, and the processor is electrically connected to the storage device. Instructions executed by the processor include building a data table of traffic flow and toll rate associated with multiple time segments. The instructions also include building a mathematical model of the traffic flow and the toll rate which includes a value of at least one parameter related to a road segment and a time segment. The instructions further include calculating a raw toll rate of the road segment and the time segment according to the values of the parameters and a rated traffic flow. Moreover, the instructions include retrieving a first announced toll rate of a previous time segment, calculating a difference between the raw toll rate and the first announced toll rate, and determining a second announced toll rate of the time segment according to the raw toll rate and the second announced toll rate.

In yet another aspect, the present disclosure is directed to a non-transitory computer readable storage medium including a computer program implementing a dynamic road pricing method. The operation of the computer program includes building a data table of traffic flow and toll rate associated with multiple time segments and building a mathematical model of the traffic flow and the toll rate. The mathematical model of the traffic flow and the toll rate includes a value of at least one parameter related to a road segment and a time segment. The operation also includes calculating a raw toll rate of the road segment and the time segment according to the values of the parameters and a rated traffic flow. Moreover, it includes retrieving a first announced toll rate of a previous time segment, calculating a difference between the raw toll rate and the first announced toll rate, and determining a second announced toll rate of the time segment according to the raw toll rate and the difference.

It is to be understood that both the foregoing general description and the following detailed description are by examples, and are intended to provide further explanation.

### BRIEF DESCRIPTION OF THE DRAWINGS

The disclosure can be more fully understood by reading the following detailed description of the embodiment, with reference made to the accompanying drawings as follows:

FIG. 1 is a flow chart of a dynamic road pricing method according to a first embodiment;

FIG. 2 is a schematic diagram of a dynamic road pricing method according to a second embodiment; and

FIG. 3 is a block diagram of a dynamic road pricing system according to a third embodiment.

### DETAILED DESCRIPTION

Reference will now be made in detail to the present embodiments, examples of which are illustrated in the accompanying drawings. Wherever possible, the same reference numbers are used in the drawings and the description to refer to the same or like parts.

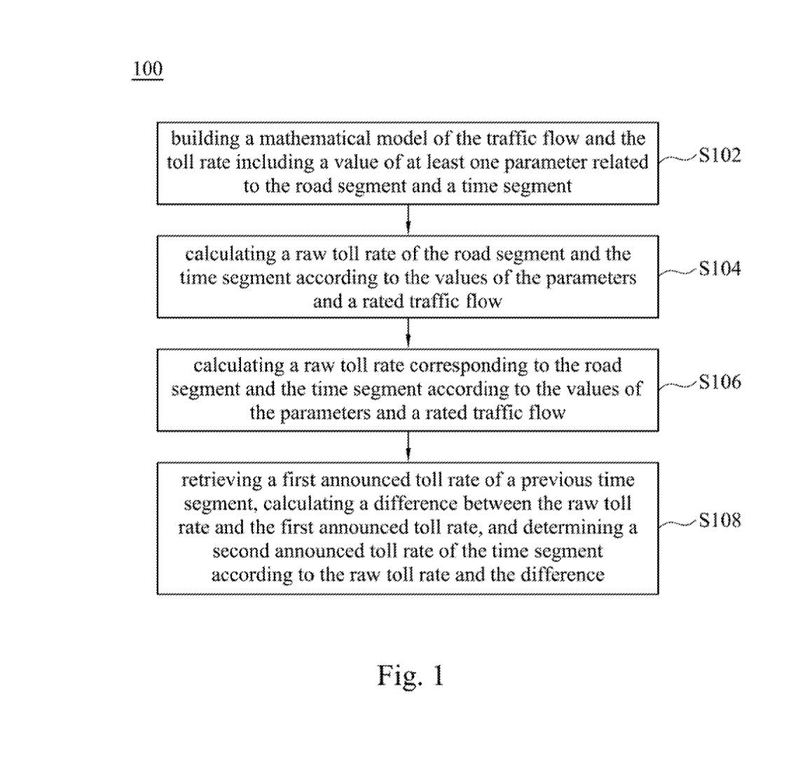

FIG. 1 is a flow chart of a dynamic road pricing method according to a first embodiment. While the process flow of dynamic road pricing method 100 is described as a number of operations in a specific order, it should be apparent to one of ordinary skill in the art that these operations may include more or fewer operations, which may be executed serially or in parallel (e.g., using parallel processors or in a multi-threading environment).

In the dynamic road pricing method 100 shown in FIG. 1, operation S102 is building a data table of traffic flow and toll rate associated with multiple time segments. To simplify the description for understanding, the data table of the traffic flow and the toll rate associates with one road segment. However, one of ordinary skill in the art can easily apply the content of the disclosure to multiple road segments without departing from the spirit and scope of the present disclosure.

Traffic flow of a road has a characteristic similar to periodicity. Commuters bring heavy traffic near main business or industrial districts around the beginning and end of office hours on weekdays. Huge traffic appears near scenic spots and shopping centers during weekends and public holidays. To utilize this characteristic, the data table of the traffic flow and the toll rate associated with multiple time segments is built according to day of week and time of day. Duration of the time segments is determined according to the changing rate of the traffic flow corresponding to the road segment. In one embodiment, the duration is 15 minutes and it is for road segments where the traffic flow changes quickly. In another embodiment, the duration is one hour and it is for road segments where the traffic flow changes slower or or limited storage space or computing resources.

Operation S104 in FIG. 1 is building a mathematical model of the traffic flow and the toll rate. The mathematical model of the traffic flow and the toll rate includes a value of at least one parameter related to the road segment and a time segment, and the time segment is one of those time segments from the data table of the traffic flow and the toll rate. In one embodiment, the time segment is 8:00-9:00 of Monday, and the part of the data table of the traffic flow and the toll rate corresponding to 8:00-9:00 of all Mondays in the database is utilized to build the mathematical model of the traffic flow and the toll rate.

Regression analysis is a statistical process for estimating relationships among variables. The variables studied are divided into one or more independent variables and a dependent variable, and a mathematical model of the dependent variable and independent variables is built. Data samples are analyzed to estimate values of parameters in the mathematical model. The purpose of regression analysis is 1) explaining the past data, and 2) predicting the future value of the dependent variable with known values of the independent variables. One of the problems that the present disclosure solves is predicting the value of a toll rate that generates a traffic flow as expected with the data table of the traffic flow and the toll rate. To apply regression analysis, the data samples are the part of the data table of the traffic flow and the toll rate associated with the time segment, the independent variable is the toll rate, and the dependent variable is the traffic flow. As a result, the values of the parameters related to the road segment and the time segment is obtained with regression analysis, and the value of the traffic flow (dependent variable) is predicted when the toll rate (independent variable) is set at a certain value.

Expectedly, an increase of the toll rate causes a decrease of the traffic flow, but whether they are inversely or exponentially related relies on data analysis to tell. After analysis and experiments, the disclosure builds the mathematical model of the traffic flow and the toll rate as follows:

F=α·T^{β}

where F is the traffic flow, T is the toll rate, and α and β are the values of the parameters. In other words, the traffic flow and the toll rate are exponentially related. The parameter β represents the concept of “price elasticity” in supply/demand model of economics, which represents how demand for a certain good varies with its price. In one embodiment, β varies between a range of −0.25 and −0.29. In another embodiment, β varies between a range of −0.22 and −0.24. These are only by examples and the disclosure is not limited thereto. The actual values of α and β are different related to different road segments and different time segments.

In the mathematical model of the traffic flow and the toll rate above, the following equation is obtained after taking logarithm:

log F=log α+β log T

It is a linear equation, which means logarithm of the traffic flow is linearly related to logarithm of the toll rate. Therefore, linear regression analysis is applicable. Linear regression analysis is a type of regression analysis studied rigorously, and used extensively in practical applications. The values of the parameters α and β which best fits the linear equation of logarithm of a and logarithm of β to the part of the data table of the traffic flow and the toll rate associated with the time segment can be obtained by minimizing the error between the equation of logarithm of traffic flow and logarithm of toll rate and the part of the data table of the traffic flow and the toll rate associated with the time segment. In one embodiment, the linear regression analysis used is linear least squares regression analysis. In another embodiment, the linear regression analysis used is linear least absolute deviation regression analysis.

After the values of the parameters are obtained in operation S104, operation S106 is calculating a raw toll rate of the road segment and the time segment according to the values of the parameters and a rated traffic flow. The rated traffic flow is determined according to a road capacity. The road capacity is a basic transportation capability of a road, which is the maximum number of vehicles passing through a cross section of the road per unit time under ideal weather or road condition (for a road with reversible lanes, it accounts for vehicles traveling in both directions. For a road with multiple lanes, it accounts for vehicles traveling on the one-way lane accommodating the most traffic.) In one embodiment, the rated traffic flow is set as the road capacity multiplied by the duration of the time segment. In another embodiment, the rated traffic flow is further adjusted to take current weather and traffic events (e.g., traffic accidents or road construction) into consideration to deal with real-time traffic condition. After the rated traffic flow is determined, the toll rate T is the only unknown value in the mathematical model of the traffic flow and the toll rate F=α·T^{β}, and the raw toll rate is calculated by applying the rated traffic flow and the values of the parameters obtained in operation S104.

In operation S108, a difference between the raw toll rate and a first announced toll rate of a previous time segment is obtained, and a second announced toll rate of the time segment is determined according to the difference and the raw toll rate. The purpose of operation S108 is to limit the difference of the first announced toll rate and the second announced toll rate such that the toll rate does not increase or decrease too fast. Since drivers entering the road right after the toll rate surges find this unacceptable, while drivers who entered the road right before the toll rate dips complain about being charged unfairly.

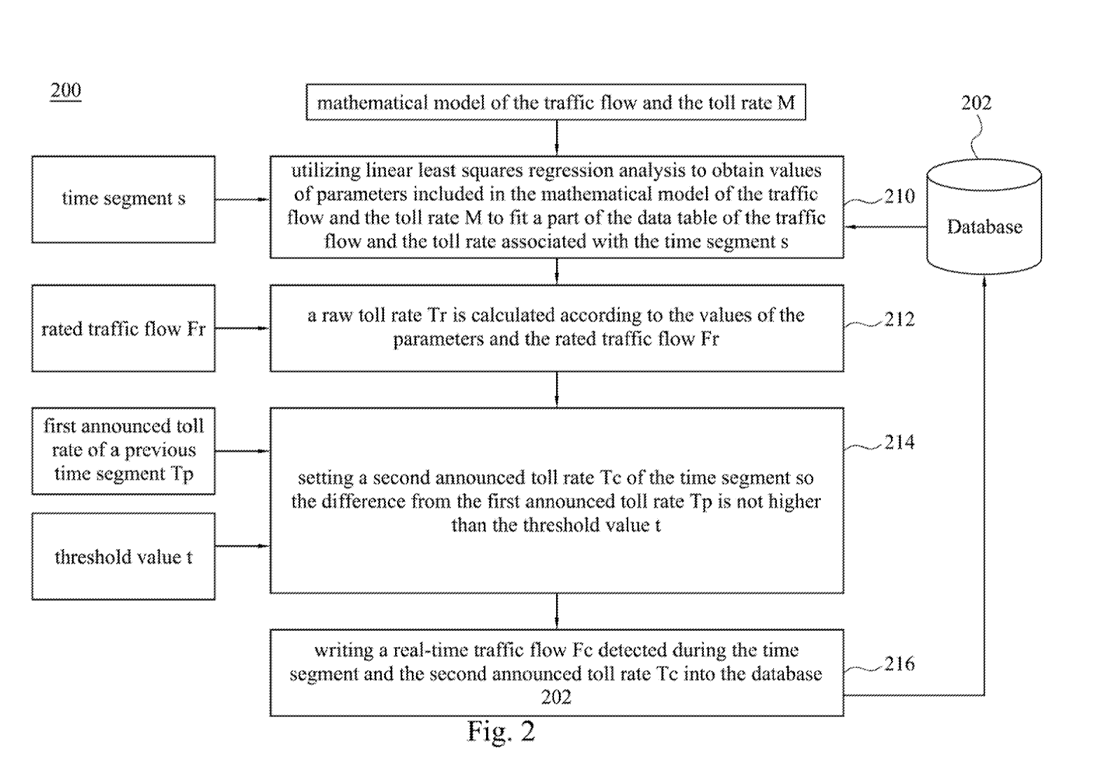

FIG. 2 is a schematic diagram of a dynamic road pricing method 200 according to a second embodiment. A database 202 is stored in a storage device and includes a data table of traffic flow and toll rate associated with multiple time segments. In operation 210, a mathematical model of the traffic flow and the toll rate M and a time segment s are input, and linear least squares regression analysis is utilized to obtain values of parameters included in the mathematical model of the traffic flow and the toll rate M to fit a part of the data table of the traffic flow and the toll rate corresponding to the time segment s in the database 202. In operation 212, the input is a rated traffic flow Fr and the values of the parameters obtained in operation 210, a raw toil rate Tr is calculated by applying the values of the parameters and the rated traffic flow Fr to the mathematical model of the traffic flow and the toll rate M.

The input of operation 214 is a threshold value t and a first announced toll rate of a previous time segment Tp. The operation 214 includes calculating a difference Tdiff of the first announced toll rate Tp and the raw toil rate Tr and comparing the difference Tdiff with the threshold value t. If the difference Tdiff is lower than the threshold value t, a second announced toll rate Tc of the time segment is set as the raw toll rate Tr. If the difference Tdiff is higher than the threshold value t, then the raw toll rate Tr is further compared with the first announced toll rate Tp. If the raw toll rate Tr is higher than the first announced toll rate Tp, the second announced toll rate Tc is set as the first announced toll rate Tp plus the threshold value t. If otherwise, the second announced toll rate Tc is set as the first announced toll rate Tp minus the threshold value t.

The threshold value t is adjustable according to day of week. During the week, drivers usually travel to commute, which means the number of passengers per vehicle is low and the trips taken are routine. As a result, the threshold value t is set at a lower value to prevent the toll rate from increasing too fast thus putting a financial burden on commuters. During weekends or public holidays, each vehicle usually carries more passengers and drivers are willing to pay more for traveling efficiently, which means the threshold value t is set at a higher value accordingly. In one embodiment, the threshold value t is set as the maximum difference accepted by drivers. In another embodiment, the threshold value t is set as the maximum toll rate difference between two consecutive time segments. In yet another embodiment, the threshold value t for the same time segment is different on each weekday.

After the second announced toll rate Tc is calculated in operation 214, operation 216 includes writing a real-time traffic flow Fc detected during the time segment and the second announced toll rate Tc into the database 202 and adding them to the data table of the traffic flow and the toil rate to include the most up-to-date data of the traffic flow and the toll rate. Since the traffic flow is also subject to other environmental factors, such as shifting of business districts or establishment of an alternative route. The environmental factors impact the pattern of the traffic flow fluctuating with time day of week and time of day). Therefore, the values of the parameters in the mathematical model of the traffic flow and the toll rate M generate a more accurate prediction of the traffic flow when the data table of the traffic flow and the toll rate in the database 202 keeps up-to-date.

The disclosure teaches how to build the mathematical model of the traffic flow and the toll rate M with the data table of the traffic flow and the toll rate and establish the relation between the traffic flow and the toll rate. Governmental transportation authorities can usually provide the data of traffic flow and toll rate, but they do not have data for all road segments or they provide data in the format of daily traffic flow, which is not sufficient for implementation of the dynamic road pricing method in the disclosure. Operation 216 can be utilized to collect the data table of the traffic flow and the toll rate by a traffic flow monitoring device.

Another embodiment of the present disclosure is a computer program implemented to execute a dynamic road pricing method. The operations of the computer program are described above and not repeated herein. The computer program is stored in a non-transitory computer readable storage medium, and a computer reads the non-transitory computer readable storage medium to execute the computer program implementing the dynamic road pricing method. The non-transitory computer readable storage medium is a read-only memory, a flash memory, a floppy disk, a hard disk, a CD/DVD-ROM, a USB memory stick, a cassette, a database accessible from the internet or any other non-transitory computer readable storage medium with equivalent functions that one of ordinary skill in the art can think of.

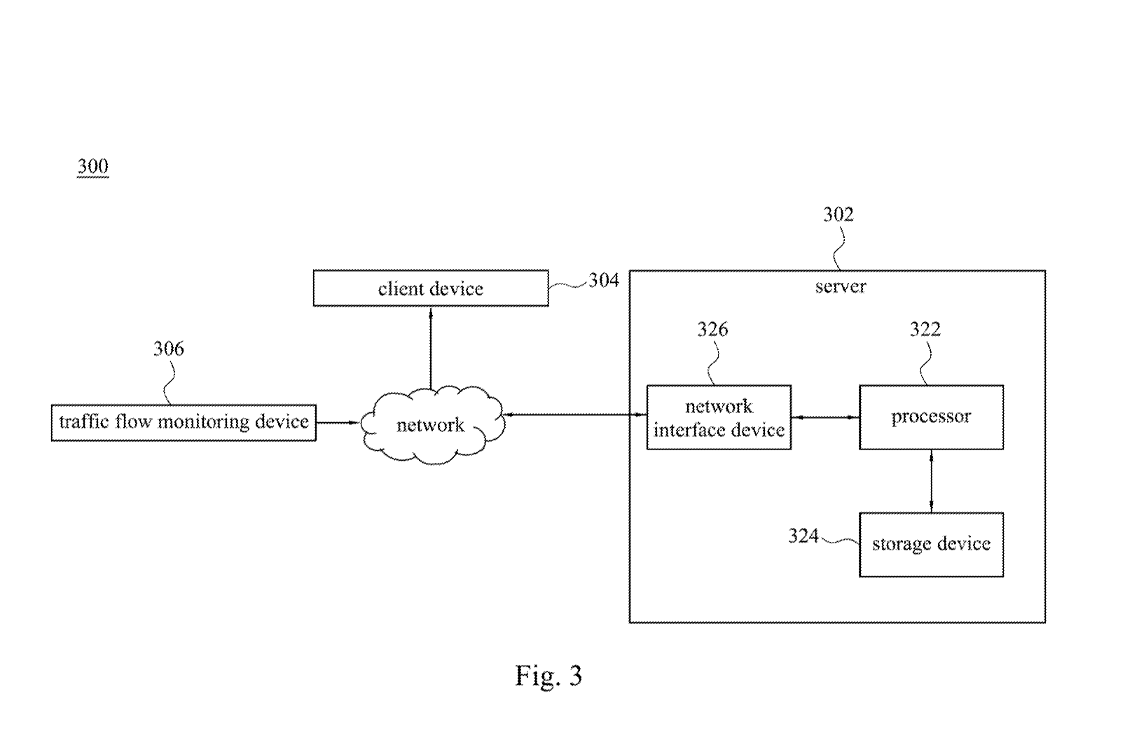

FIG. 3 is a block diagram of a dynamic road pricing system according to a third embodiment. The dynamic road pricing system 300 includes a server 302, a client device 304, and a traffic flow monitoring device 306. The server 302 further includes a processor 322 (e.g., CPU), a storage device 324 (e.g., a flash memory and/or a hard disk), and a network interface device 326 (e.g., a network interface card or a USB network interface controller). The processor 322 is electrically connected to the storage device 324 to read and write data stored in the storage device 324. The processor 322 is also electrically connected to the network interface device 326 to connect to the Internet in a wired or wireless way. The client device 304 and the traffic flow monitoring device 306 are both connected to the Internet in a wired or wireless way.

A database is stored in the storage device 324 electrically connected to the processor 322. Instructions executed by the processor 322 include: 1) building a data table of traffic flow and toll rate associated with multiple time segments in the database in the storage device 324, 2) building a mathematical model of the traffic flow and the toll rate with the mathematical model including a value of at least one parameter of a road segment during a time segment, 3) calculating a raw toll rate of the road segment and the time segment according to the values of the parameters and a rated traffic flow, 4) retrieving a first announced toll rate of a previous time segment, calculating a difference between the raw toll rate and the first announced toll rate, and determining a second announced toll rate of the time segment according to the raw toll rate and the difference.

The processor 322 announces the second announced toll rate via the Internet after it is determined. In one embodiment, the server 302 sends the second announced toll rate to the client device 304 through the network interface device 326. The client device 304 is a controller for an electrical road sign at an entrance of the road segment and displays the second announced toll rate on the electrical road sign after receiving the second announced toll rate of the time segment. In another embodiment, the server 302 transmits the second announced toil rate to another web server (not shown in the figure) through the network interface device 326. The client device 304 is a personal computer or mobile device with a web browser, and visits the web server to get the second announced toll rate. In yet another embodiment, the server 302 also serves as the web server.

The traffic flow monitoring device 306 detects a real-time traffic flow of the road segment, and transmits the real-time traffic flow to the server 302 via the Internet. After the second announced toll rate is determined, the server 302 controls the processor 322 to store the second announced toll rate and the real-time traffic flow detected by the traffic flow monitoring device 306 during the time segment to the database in the storage device 324 to update the data table of the traffic flow and the toll rate.

In one embodiment, the traffic flow monitoring device 306 is an in-roadway inductive-loop detector. In another embodiment, the traffic flow monitoring device 306 is a pressure-sensitive sensor. In yet another embodiment, the traffic flow monitoring device 306 is a computer vision system including a camera at the side of the road and the real-time traffic flow detected by processing images taken by the camera. In other embodiments, the traffic flow monitoring device 306 is combined with existed components on road ways such as electronic toll collection devices or sensors for detecting speeding drivers.

Although the present disclosure has been described in considerable detail with reference to certain embodiments thereof, other embodiments are possible. Therefore, the spirit and scope of the appended claims should not be limited to the description of the embodiments contained herein.

It will be apparent to one of ordinary skill in the art that various modifications and variations can be made to the structure of the present disclosure without departing from the scope or spirit of the disclosure. In view of the foregoing, it is intended that the present disclosure cover modifications and variations of this disclosure provided they fail within the scope of the following claims.

What is claimed is:

1. A dynamic road pricing method, comprising:
building a data table of traffic flow and toll rate associated with a plurality of time segments;
building a mathematical model of the traffic flow and the toll rate, wherein the mathematical model of the traffic flow and the toll rate includes a value of at least one parameter related to a road segment and a time segment;
calculating a raw toll rate of the road segment and the time segment according to the values of the parameters and a rated traffic flow; and
retrieving a first announced toll rate of a previous time segment, calculating a difference between the raw toll rate and the first announced toll rate, and determining a second announced toll rate of the time segment according to the raw toll rate and the difference.

2. The dynamic road pricing method as claimed in claim 1, wherein determining the second announced toll rate according to the raw toll rate and the difference comprises:
setting the second announced toll rate as the raw toll rate if the difference is lower than a threshold value.

3. The dynamic road pricing method as claimed in claim 1, wherein determining the second announced toll rate according to the raw toll rate and the difference comprises:
setting the second announced toll rate as the first announced toll rate plus a threshold value if the difference is higher than the threshold value and the raw toll rate is higher than the first announced toll rate.

4. The dynamic road pricing method as claimed in claim 1, wherein determining the second announced toll rate according to the raw toll rate and the difference comprises:
setting the second announced toll rate as the first announced toll rate minus a threshold value if the difference is higher than the threshold value and the raw toll rate is lower than the first announced toll rate.

5. The dynamic road pricing method as claimed in claim 1, further comprising: utilizing a part of the data table of the traffic flow and the toll rate corresponding to the time segment and the mathematical model of the traffic flow and the toll rate for obtaining the values of the parameters related to the road segment and the time segment.

6. The dynamic road pricing method as claimed in claim 1, wherein the mathematical model of the traffic flow and the toll rate is:
F=α·T^{β}, wherein F is the traffic flow, T is the toll rate, and α and β are the values of the parameters.

7. The dynamic road pricing method as claimed in claim 6, wherein the operation of obtaining the values of the parameters further comprises: taking logarithm of the mathematical model of the traffic flow and the toll rate such that the logarithm of the traffic flow and the logarithm of the toll rate are linearly related, and obtaining the values of the parameters of the mathematical model of the traffic flow and the toll rate to fit a part of the data table of the traffic flow and the toll rate associated with the time segment with linear least squares regression analysis.

8. The dynamic road pricing method as claimed in claim 1, wherein the data table of the traffic flow and the toll rate is collected by a traffic flow monitoring device.

9. The dynamic road pricing method as claimed in claim 8, further comprising:
adding a real-time traffic flow detected by the traffic flow monitoring device during the time segment and the second announced toll rate into the data table of the traffic flow and the toll rate after the second announced toll rate is determined.

10. A dynamic road pricing system comprising:
a storage device, wherein a database is stored; and
a processor, electrically connected to the storage device, wherein the processor is configured for:
building a data table of traffic flow and toll rate associated with a plurality of time segments in the database in the storage device;
building a mathematical model of the traffic flow and the toll rate, wherein the mathematical model of the traffic flow and the toll rate includes a value of at least one parameter related to a road segment and a time segment;
calculating a rave toll rate of the road segment and the time segment according to the values of the parameters and a rated traffic flow, and
retrieving a first announced toll rate of a previous time segment, calculating a difference between the raw toll rate and the first announced toll rate, and determining a second announced toll rate of the time segment according to the raw toll rate and the difference.

11. The dynamic road pricing system as claimed in claim 10, wherein the processor compares the difference and a threshold value and sets the second announced toll rate as the raw toll rate if the difference is lower than the threshold value.

12. The dynamic road pricing system as claimed in claim 10, wherein the processor compares the difference and a threshold value and sets the second announced toll rate as the first announced toll rate plus the threshold value if the difference is higher than the threshold value and the raw toll rate is higher than the first announced toll rate.

13. The dynamic road pricing system as claimed in claim 10, wherein the processor compares the difference and a threshold value and sets the second announced toll rate as the first announced toll rate minus the threshold value if the difference is higher than the threshold value and the rain toll rate is lower than the first announced toll rate.

14. The dynamic road pricing system as claimed in claim 10, wherein the processor utilizes a part of the data table of the traffic flow and the toll rate associated with the time segment and the mathematical model of the traffic flow and the toll rate for obtaining the values of the parameters related to the road segment and the time segment.

15. The dynamic road pricing system as claimed in claim 10, wherein the mathematical model of the traffic flow and the toll rate is:
F=α·T^{β}, wherein F is the traffic flow, T is the toll rate, and α and β are the values of the parameters.

16. The dynamic road pricing system as claimed in claim 15, wherein the processor executes the following instructions for obtaining the values of the parameters:
taking logarithm of the mathematical model of the traffic flow and the toll rate such that the logarithm of the traffic flow and the logarithm of the toll rate are linearly related;
utilizing the mathematical model of the traffic flow and the toll rate to fit a part of the data table of the traffic flow and the toll rate associated with the time segment; and
obtaining the values of the parameters with linear least squares regression analysis.

17. The dynamic road pricing system as claimed in claim 10, further comprising:
a traffic flow monitoring device configured to collect the data table of the traffic flow and the toll rate.

18. The dynamic road pricing system as claimed in claim 17, wherein the processor adds a real-time traffic flow detected by the traffic flow monitoring device during the time segment and the second announced toll rate to the data table of the traffic flow and the toll rate in the database in the storage device.

19. A non-transitory computer readable storage medium to store a computer program to execute a dynamic road pricing method, the dynamic road pricing method comprising:
building a data table of traffic flow and toll rate associated with a plurality of time segments;
building a mathematical model of the traffic flow and the toll rate, wherein the mathematical, model of the traffic flow and the toll rate includes a value of at least one parameter related to a road segment and a time segment;
calculating a raw toll rate of the road segment and the time segment according to the values of the parameters and a rated traffic flow; and
retrieving a first announced toll rate of a previous time segment, calculating a difference between the raw toll rate and the first announced toll rate, and determining a second announced toll rate of the time segment according to the raw toll rate and the difference.
